(19) United States
(12) Patent Application Publication
(10) Pub. No.: US 2020/0325550 A1
(43) Pub. Date: Oct. 15, 2020

(54) METHOD FOR FORMING MATERIALS SUCH AS LEATHER AND HIDE

(71) Applicant: PERSICO S.P.A., Nembro (IT)

(72) Inventor: Romeo MAZZON, Meda (MB) (IT)

(21) Appl. No.: 16/303,503

(22) PCT Filed: Oct. 13, 2016
(86) PCT No.: PCT/IB2016/056117

§ 371 Date: Nov. 20, 2018

(30) Foreign Application Priority Data
May 24, 2016 (IT) 102016000053036

(51) Int. Cl. C14B 1/44; B29C 51/42; B29C 51/00; B29C 51/36; B29C 51/26; B60R 13/02; B29C 51/10

(52) U.S. Cl. CPC C14B 1/44; B29C 51/428; B29C 51/002; B29C 51/36; B29K 2075/00; B60R 13/0243; B60R 13/0256; B29C 51/10; C14B 2700/28; B29C 51/262

(57) ABSTRACT

A method for forming leather and hide is used for manufacturing composite panels for automotive components, such as doors, dashboards and the like. A product is made from the method for forming leather and hide.

The present invention relates, in general, to the forming of hide, wherein this term refers particularly to leather, hide and other similar materials, preferably but not exclusively natural ones, since, as will be explained hereafter, the invention is applicable in principle also to other materials or substrates, whether simple or composite, possibly also textile ones.

Therefore, reference will generally and alternatively be made below to leather and hide to indicate these various materials that can be used with the invention; unless otherwise specified or clarified in the context, this introductory statement will have to be taken into account when reading this description.

In particular, the invention relates to the processing of hide to form pieces having desired configurations, which may also be complex and large, while avoiding or minimizing the use of seams or joints of any kind (e.g. glueing, tacking, etc.).

As will become apparent below, this is particularly advantageous for the production of automotive components such as panels, dashboards and the like.

As is known, in fact, leather and hide are generally widely used for finishing the passenger compartments of cars; this applies to all components in view, such as dashboards, the inner door panels, armrests, and also seats.

Some of these components may have rather complex shapes, with protrusions, recesses, more or less sharp corners, undercuts, concave or convex surfaces, and so on; moreover, the dashboards and doors of some cars are quite big, with areas in the order of 0.5-1 m², so that it is often necessary to join two or more pieces of leather or hide, which have to be stitched and/or glued together.

This implies both a limitation from an aesthetic and tactile viewpoint, since the joints interrupt the continuity of the hide, which cannot therefore remain smooth and even, and an increase in processing times and/or costs, because for finishing a door or a dashboard it is necessary to cut to size the different pieces of hide first, and then stitch or glue them together.

This inevitably requires time, which in the glueing case is also affected by the curing time of the adhesive in use.

A further aspect that concerns the state of the art for automotive applications is that, when manufacturing components for doors, dashboards and other parts, the leather coating is fixed onto a panel of thermoformable synthetic material (such as foam polyurethane or polystyrene) during a moulding step.

This implies some complexity because, de facto, it is necessary to press together the leather or hide panel and the thermoformable panel, causing the former to adhere to the latter while at the same time giving the desired shape to the resulting piece.

The different mechanical characteristics of the materials of the panel and of the leather coating require high processing accuracy and precise control of various parameters of the production process (e.g. dimensional tolerances, temperatures, moulding times and pressures, etc.) for the fixing to occur appropriately, without any defects such as wrinkles or local material detachment.

In the light of this preamble, it can be stated that a technical problem at the basis of the present invention is to provide a forming process for leather or hide in general that allows overcoming the above-described drawbacks of the prior art.

The idea that solves this problem is to provide a method that allows forming leather or hide in general with desired shapes in an autonomous manner, i.e. without necessarily having to fix the leather coating to thermoformable panels or other substrates for moulding it.

In this way, it is possible to obtain a moulded product with the desired shape, which can then be directly used for applications such as the finishing of internal components of cars, and also other products, such as, for example, pieces of furniture and other interior items, shoes, clothes and leather goods.

According to a preferred embodiment of the invention for automotive components, an expandable resin or foam can be applied, e.g. sprayed, onto the formed leather manufacture in order to obtain the desired thickness and/or consistency of the finished part.

This avoids the need for coupling the leather coating to a thermoformable panel, which would lead to the previously discussed problems.

The features of the method according to the invention are more specifically set out in the claims appended to this description.

The invention also includes a product obtained by using the above-mentioned forming method, in particular an automotive component or the like.

The features of the invention, as well as the effects and advantages thereof, will become more apparent in the light of the following description of one possible embodiment, provided herein by way of non-limiting example with reference to the annexed drawings, wherein:

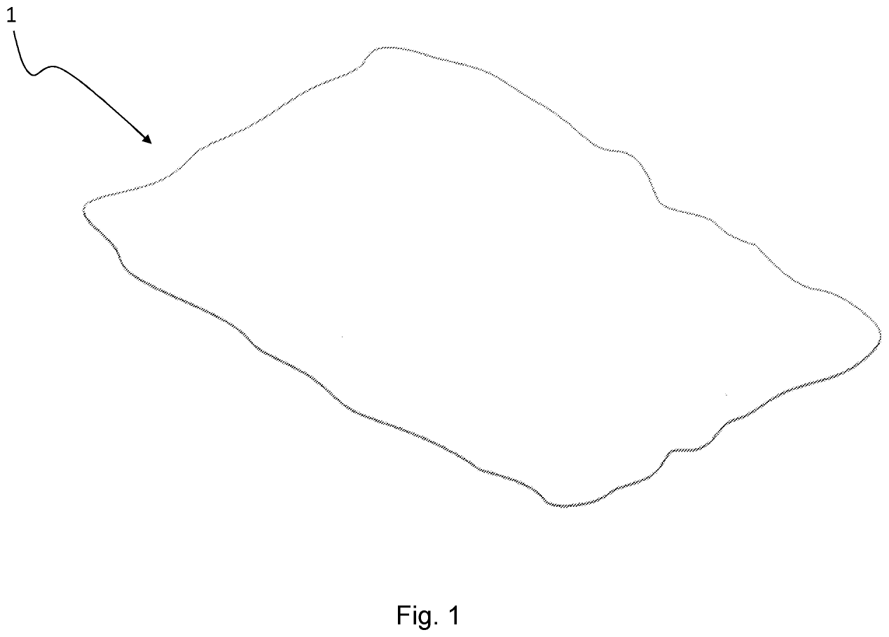

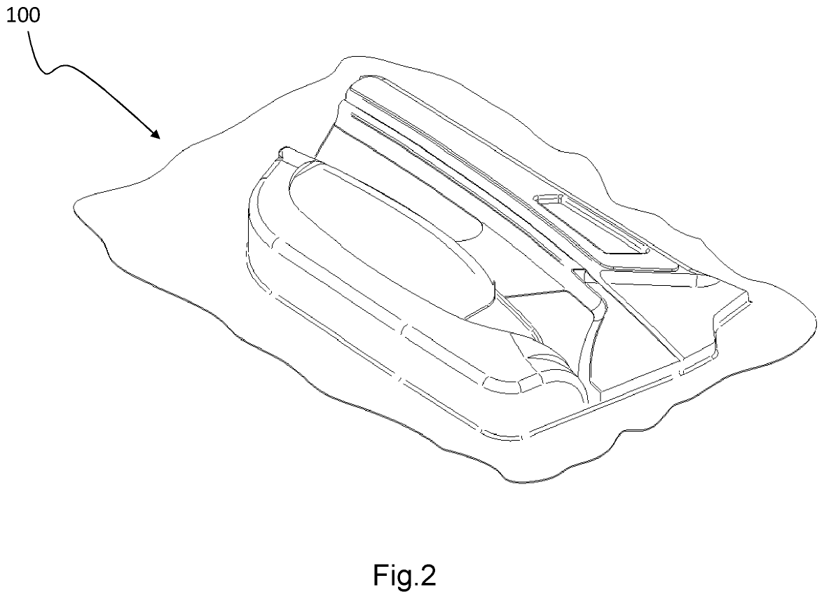

FIGS. 1 and 2 are perspective views of a leather sheet, respectively before and after the execution of the forming method according to the present invention;

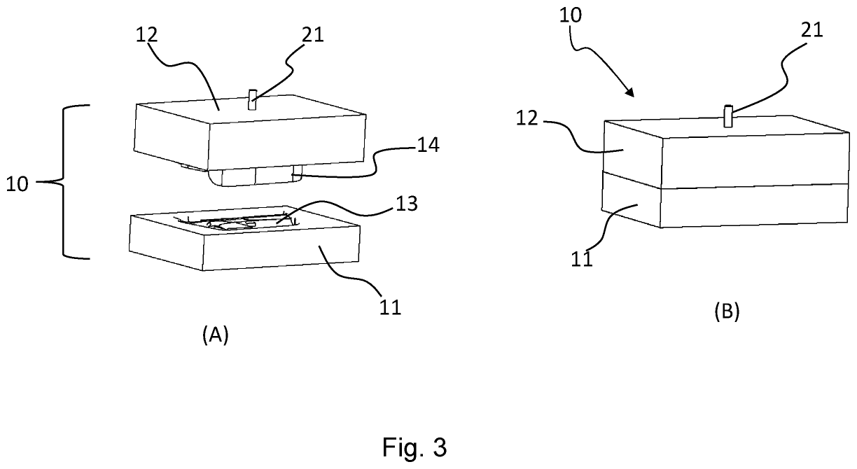

FIGS. 3 (A), (B) schematically show a mould for the execution of the method of the invention, in respective operating conditions;

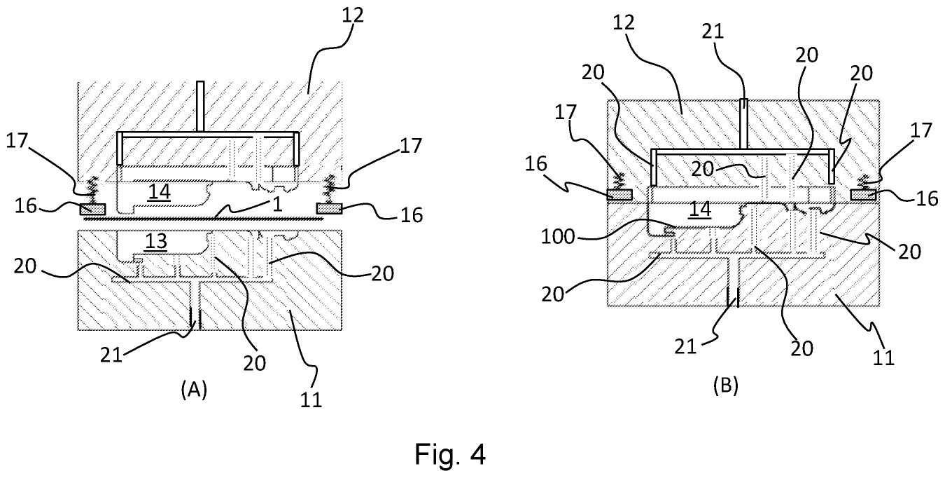

FIGS. 4 (A), (B) show corresponding sectional views of the mould of FIG. 3;

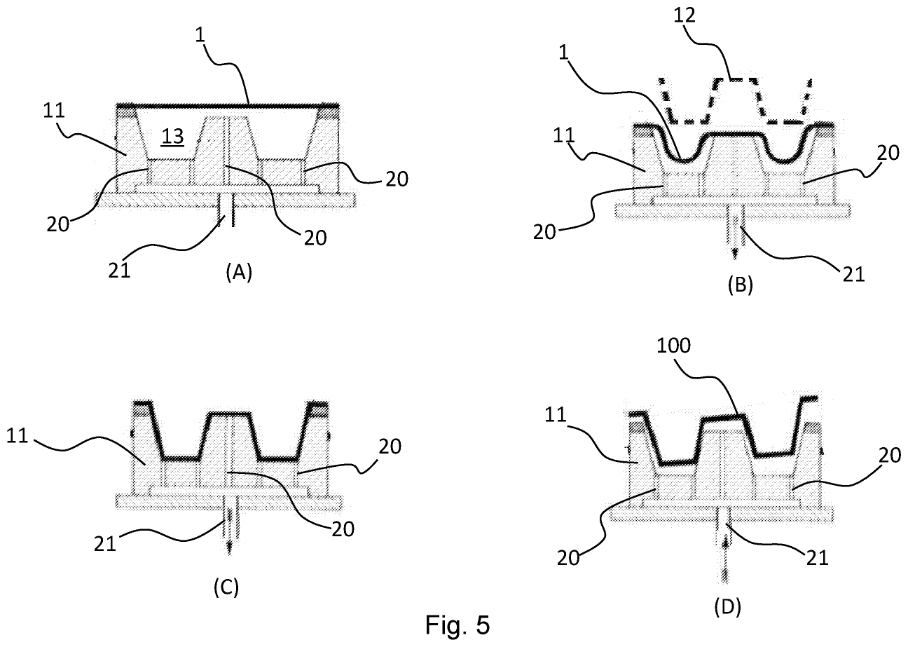

FIGS. 5 (A), (B), (C), (D) schematically show some steps of the method for forming a leather sheet according to the invention;

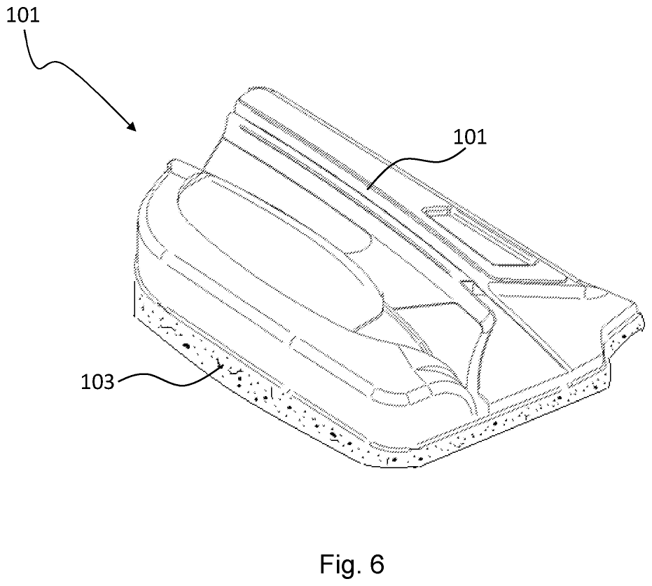

FIG. 6 shows a panel for automotive doors, coated with the product of FIG. 2.

With reference to the above-listed drawings, numeral 1 designates as a whole a sheet of natural hide or leather for internal components of a car, which is shown in an initial semifinished condition, ready for the forming process according to the invention.

With particular reference to the first drawing, the sheet 1 is preferably a flat semifinished product, i.e. with no bends, ribs, stitches, seams or the like.

In this case, the leather sheet 1 has a substantially square shape, with sides of approx. 90 cm and a thickness of 3-5 mm; the dimensions and thickness of the sheet 1 may however vary according to the type of product for which it is intended.

In fact, in the example shown in the drawings the sheet 1 is intended as an internal covering for the door of a car and therefore has a substantially quadrilateral shape, but for other products such as dashboards or headrests or also the seats of a car, the sheet may be shaped differently (e.g. triangular, circular, curvilinear, polygonal or with a complex outline); this is also true for applications of the invention to products in fields other than the automotive one.

Before proceeding any further with this description, it is worth pointing out right away that the elements of the invention, as well as their configuration or representation as shown in the drawings, can be combined as required in one or more embodiments, since they are not limited to the examples shown in the drawings.

Therefore, in this description any reference to “an embodiment” will indicate that a particular configuration, structure or feature described in regard to an element is comprised in at least one embodiment.

Furthermore, any particular configuration, structure or feature may be combined in one or more embodiments in any way deemed appropriate. The references below are therefore used only for simplicity's sake and do not limit the protection scope or extent of the invention.

This having been said, the invention will now be described on the assumption that the natural hide or leather of the sheet 1 has preferably been treated in a conventional manner, i.e. tanned and treated as usual in the art, for making it suitable for forming without needing any further processing.

In other words, this means that this semifinished product is stable in terms of physical and/or mechanical characteristics, such as surface finish (smooth, rough, etc.), colour, flexibility, tensile strength, etc. Furthermore, in accordance with the method of the invention, the leather or hide sheet 1 can, in the initial condition, absorb liquids such as, in particular, water; therefore, it is not watertight, or anyway not so much that it cannot be imbibed with liquids, depending on the requirements of the process that will be further described below.

In this regard, it must be pointed out that, in fact, during an initial step of the process the semifinished leather or hide sheet 1 is moistened and/or wetted, so as to imbibe a quantity of water that preferably depends on the size and/or thickness of the sheet, on its quality and origin (e.g. bovine leather is different according to the part of the animal from which it is derived, and the same applies to hide obtained from other animals), and also on the type of configuration that it will have to take after the forming process (e.g. with bends, protrusions, recesses, ribs, which may be more or less deep, round or sharp, etc.).

The step of moistening and/or wetting the leather sheet 1 can be carried out in any way deemed appropriate; a first method requires immersing the sheet 1 into a water bath, possibly containing additives such as, for example, substances that may facilitate the next forming operation or that may improve the characteristics of the leather.

The time of permanence in the bath depends on various factors, such as the capability of the leather sheet 1 to get imbibed and its thickness; in general, it can be stated that it is anyway preferable to obtain an absorption of water by the sheet 1 as uniform as possible, i.e. an even depth of penetration into the thickness of the leather, so that the sheet 1 will have a substantially constant behaviour throughout its surface.

To this end, a time of immersion of the sheet 1 into water of at least approx. 15-30 is usually required.

As an alternative, the leather can be wetted or moistened by spraying water onto it or by storing the leather 1 in a humid environment (e.g. a controlled humidity chamber); in both cases, the treatment will last as necessary to ensure an even imbibition of the leather.

Once this initial preparation step is over, the purposes of which will become more apparent hereafter, the sheet 1 is loaded into a mould 10, shown in FIGS. 3 and 4.

This mould is preferably made up of two parts or half-moulds 11 and 12, i.e. a preferably fixed first lower part and a second upper part movable relative to the first one to allow opening and closing the mould 10.

In this example, the lower part 11 of the mould is concave or mostly concave, its profile having a female cavity 13, whereas the upper part 12 is mostly convex, thus having a relief 14 substantially acting as a punch.

Of course, this division of the mould is merely illustrative and not necessarily the only possible one, since it may be easily reversed, i.e. with the cavity in the upper part 12 and the relief 14 on the upper part 11.

Furthermore, it is apparent that the configuration of the working surfaces of the half-moulds 11, 12, i.e. those in contact with the sheet 1 to be formed, which in this case comprise the cavity 13 and the relief 14, will depend on the final shape that must be given to the leather sheet 1.

It is therefore understandable that the car door case taken into consideration in the drawings is only one of many possible cases, in that the half-moulds 11, 12 may be given many other configurations as well, as a function of the other products to be manufactured.

Thus, for example, still with reference to the automotive industry, components like dashboards and seats will require half-moulds 11, 12 that are very different from those shown herein, and the same will apply to products intended for other purposes, such as the furnishing and nautical fields, etc.

Preferably, the mould 10 is also equipped with means 16 for retaining and/or tensioning the leather sheet 1; such means are useful for promoting the adaptation of the sheet 1 to the working surfaces of the half-moulds 11, 12, thus avoiding the formation of creases or wrinkles that might impair the quality of the final piece.

As means for retaining and/or tensioning the sheet, a frame 16 or the like is used in this case, which is adapted to elastically press the edge of the sheet 1 against the edge of the lower part 11 of the mould, so as to keep it slightly tensioned during the initial forming steps, thus promoting its adaptation to the surface of the relief 14 of the upper half-mould 12.

To this end, the mould 10 includes thrust elements 17, such as springs, hydraulic or pneumatic pistons, or the like, for pressing the frame 16 against the edge of the leather sheet 1 with controlled force, so as to facilitate the forming of the sheet as it is pressed in the mould 10.

The lower and upper parts or half-moulds 11 and 12 are mounted on a press, which is not shown in the drawings because it is of a type known in the art; in this case, the press shall include a movable ram associated with the upper part 12 of the mould 10, adapted to bring it close to or away from the lower part 11 for opening or closing the mould during the various steps of the forming process.

In accordance with the invention, the mould 10 is also equipped with means for creating a vacuum therein.

In particular, such means are adapted to create a vacuum at the sheet 1 when the mould 10 is closed and the sheet is interposed between the lower part and the upper part 11, 12.

For this purpose, the latter include intake channels 20 that allow sucking the air that is present between the leather sheet 1 and the surfaces of the cavity 13 and/or of the relief 14, so that it can accurately adapt to said surfaces, i.e. with no creases, wrinkles and the like.

Of course, the dimensions and number of the channels in the mould may vary according to the shape of the part to be manufactured and of the cavities 13 and/or reliefs 14 that are present in the half-moulds 11, 12.

In the example shown in the drawings, the channels 20 are associated with both the lower part 11 and the upper part 12 of the mould, although the air evacuation channels 20 may possibly be present only in either the lower part 11 or the upper part 12 of the mould.

This allows creating a vacuum and, more in general, applying a predetermined force onto the leather sheet 1 by generating a pressure drop on one or both sides thereof.

In addition, the channels 20 are connected to a compressor external to the mould 10 (not shown in the drawings), which sucks the air in order to obtain the pressure drop required by the forming process. Preferably, the moulding pressure is lower than the atmospheric pressure.

For this reason, the mould includes one or more fittings 21 for external ducts or pipes (not shown in the drawings) allowing the connection to the compressor.

Advantageously, in a preferred embodiment of the invention it is also possible to supply air into the channels 20 by blowing it through the same compressor or other means, in order to promote the final step of removing the formed piece at the end of the process.

Another important aspect of the invention lies in the fact that the mould 10 is thermally conditioned; it can therefore undergo successive heating and cooling cycles, during which it is made to reach temperatures in the working areas preferably in the order of 50-90° C., to be then cooled to ambient temperature or not much more, so that the formed sheet 1 can be removed.

Several solutions are possible as to the thermal conditioning of the mould 10, but preferably this occurs in accordance with the present Applicant's teachings, i.e. with the capability of providing fast successive heating and cooling cycles, for higher productivity levels.

One example of this type of mould has been described in the published European patent application EP 2 962 825 filed by the present Applicant, the contents of which are wholly referred to herein.

For brevity, the following will only describe some structural and/or functional aspects of the mould 10 that are necessary or useful for understanding the present invention; for further details, reference should be made to the above-mentioned patent application and to the moulds created by the present Applicant.

In summary, it can be said that the parts or half-moulds 11, 12 are equipped with inserts where a conditioning fluid, preferably water, but it may also be diathermic oil or a mixture of fluids (e.g. glycol water or the like), can circulate at a different rate than the one circulating in the other sections of the half-moulds.

The inserts are essentially small blocks installed in the half-moulds 11, 12 in positions corresponding to the cavity 13 and the relief 14, which inserts, their mass being smaller, have less thermal inertia and can be heated and cooled quickly by supplying them with a fluid separately from the other parts of the half-moulds 11, 12. The process for forming the semifinished leather sheet 1 by using the press 10, as schematically shown in FIGS. 5 (A)-(D), takes place as follows.

After having been moistened and/or wetted as previously explained, the leather sheet 1 is introduced into the mould 10 by laying it onto the lower part or half-mould 11 (FIGS. 4(A), 5(A)); in this step, both parts 11, 12 of the mould 10 are preferably heated to a preset temperature, which may be lower than the temperature that will be used during the next steps for forming the leather sheet 1.

The mould 10 is then closed by lowering the upper part 12 against the lower part 11 (FIGS. 3(B) and 4(B)); at this stage, the frame 16 will go back to allow the mould 10 to be sealed, so that a vacuum can be created therein.

It should be noted that, as the parts or half-moulds 11 and 12 of the mould approach each other, the relief 14 of the upper one progressively engages with the cavity 13 of the lower one and, generally speaking, a general coupling is effected between all male-female portions of both.

The leather sheet 1 in between will bend following the profile of the surfaces, while the retaining and/or tensioning means, i.e. the frame 16 with the thrust elements 17, apply a force onto the edge of the sheet 1 to create a slight tension useful for preventing the formation of undesired creases.

At the same time, air starts being sucked out of the channels 20, and the sheet 1 is adapted to the surfaces of the cavity 13 and of the relief 14.

It must be underlined that the adaptation of the sheet to the working surfaces of the half-moulds 11, 12 is facilitated by the fact that it has been previously moistened or wetted to make it softer and more flexible.

Once the mould 10 has been closed, its parts 11, 12 are brought to the desired temperature for the aforesaid process, i.e. 50-90° C., although different values, whether higher or lower than this range, may be used depending on the type of material to be processed (leather or various types of hide), on the thickness thereof, on the processing times, etc. However, unexpected good results have been attained with values in the range of 60° C. and 80° C.

Throughout this step a vacuum is maintained in the mould 10, thus obtaining two advantageous effects.

A first effect is, as already mentioned, the suction effect exerted on the leather sheet 1, which promotes the adaptation of the latter to the working surfaces of the mould.

The second advantageous effect lies in the fact that the presence of a vacuum in the mould 10 promotes the evaporation of the water that the leather has imbibed, resulting in the latter becoming progressively dry.

In fact, evaporation temperature decreases as pressure is reduced, and therefore the water imbibed by the leather can be made to evaporate within the mould 10, at relatively low temperatures (50-90° C. or even less) that can be easily withstood by the leather, with no significant damage or alteration of its original physical and aesthetic characteristics.

By applying a vacuum to both faces of the leather sheet 1, the water it has imbibed can be effectively removed also from the innermost points of its section; this will also reduce the times of the leather forming cycle, since the amount of removed vapour will increase.

Note also that the vapour is sucked by the compressor external to the mould 10 along with the air that is present therein, thus reducing the drying time, on the one hand, and, on the other hand, preventing the formation of bubbles of water vapour between the leather 1 and the surfaces of the cavity 13 and/or of the relief 14; such bubbles might cause defects to arise on the surface of the leather at the end of the process.

Therefore, thanks to these characteristics of the process, as the leather dries it will optimally adhere to the inner surfaces of the mould 10, so that a final product 100 having the desired shape will be obtained, just like the car door liner shown in FIG. 2.

The product 100 thus made has optimal physical and aesthetic characteristics, because the forming is permanent, since it cannot be reversed even in the presence of humidity or in case of subsequent contact between the leather and water, and also because the surface finish of the part remains unchanged compared to the initial one of the semifinished flat sheet 1.

It follows, therefore, that the product 100 can be used as is in the next production steps.

For example, in the case of an automotive component like a door panel 101, shown schematically in FIG. 6 (which might also be a dashboard or a headrest or other components, as already discussed), a resin or another expanding compound 103, such as a polymeric or polyurethane-based resin or the like, can be applied directly onto the product 100 in order to make a panel 101 that can then be mounted on the car body after trimming and after the addition of attachments such as handles, buttons, etc., without requiring any further thermoforming steps for assembling the leather together with the base, as was the case in the prior art.

In fact, the product 100 obtained at the end of the hot forming in the mould 10 with the process of the invention has such characteristics of rigidity and stability as to be able to withstand the application of (by spraying, pouring or the like) a fluid product like a liquid resin, suitable for producing an expanded structure or matrix 103 that is light and rigid or semirigid like foam or sponge, whether with open or closed cells (e.g. polyurethane, polyethylene, polystyrene, etc.).

The union between the leather product 100 and the expanded structure 103 is optimal because the latter adheres to the former as it is moulded, so that a good physical bond can be established between them, possibly fortified by adding appropriate glues or additives to the expanding material 103.

In light of the above, it is possible to understand how the forming process for leather and hide in general according to the invention can solve the underlying technical problems.

In fact, it allows forming hide as is, i.e. without necessarily having to associate it with a panel or another support substrate, as was required in the prior art.

This considerably simplifies the steps of the production process for automotive, furnishing, nautical and other components in any industrial field wherein products with leather coatings have to be manufactured, assembled with thermoformable support structures.

As already explained, this result is made possible by the fact that the leather product 100 formed by using the process of the invention has a stable configuration, so that it can even serve as a support for the application of expanding polymeric compounds useful for making the aforesaid panels.

In other words, it can be stated that the method of the invention allows reversing the current paradigm in the production of panels coated with leather or hide, wherein the panels support the leather and are thermoformed together with the latter to obtain the final assembly.

It follows that the invention opens up new opportunities in this field, with a potential extension of the application base of leather-coated products, which is currently limited to high-end, expensive products, as is the case of cars equipped with leather trims.

Of course, the invention may be subject to variations with respect to the description provided so far.

In fact, although in the example taken into account herein the leather sheet 1 is a single-layer sheet, since this is undoubtedly the most frequent case, the forming process according to the invention can also be implemented on sheets comprising two or more overlapped layers, e.g. obtained by rolling thin leather substrates of various types and thickness.

Therefore, a bovine leather layer may be joined to another more valuable layer made of bovine hide or the like (e.g. chamois, reindeer, crocodile, etc.): in this way, different materials can be processed by exploiting the above-described properties of leather, which serves as a base for a different material that could not otherwise be processed in the same manner or anyway with the same results.

It must also be pointed out that, although the method has been conceived for natural hide, it can nevertheless be employed also for artificial leather having the above-described physical characteristics.

These and other variants will still fall within the scope of the following claims.

1. Method for forming leather and hide materials, comprising forming a sheet of the materials by processing the sheet with a mould, wherein the sheet is in a substantially wet and/or moist condition for processing in the mould.

2. Method according to claim 1, wherein the processing in the mould occurs in hot conditions.

3. Method according to claim 2, wherein the processing in the mould occurs at temperatures between 50° C. and 90° C.

4. Method according to claim 1, wherein the processing in the mould substantially occurs in vacuum conditions.

5. Method according to claim 4, comprising a step of sucking air from the mould to maintain said vacuum conditions.

6. Method for manufacturing panels comprising a support structure, selected from the group consisting of a polymeric foam structure or matrix, a coating sheet made of leather, hide and similar materials, wherein said sheet is formed by using a method according to claim 1.

7. Method for manufacturing panels according to claim 6, comprising a step of applying an expanding compound, selected from the group consisting of a resin, a mixture or the like, onto the formed coating sheet of leather or hide.

8. Mould for implementing the method according to claim 1, comprising means for creating a vacuum therein.

9. Mould according to claim 8, comprising means for thermal conditioning, to perform heating and cooling cycles can be carried out.

10. Mould according to claim 8, comprising a first lower part or half-mould and a second upper part or half-mould adapted to be coupled together to define cavities and/or reliefs where air is sucked for creating vacuum conditions within the mould.

11. Panel for automotive or furniture components or for other applications, comprising a finishing or coating sheet or layer made of leather or hide, formed by using the method according to claim 1, wherein a polymeric foam structure or matrix is applied onto the finishing or coating sheet or layer.
